(19) United States
(12) Patent Application Publication
(10) Pub. No.: US 2025/0111267 A1
(43) Pub. Date: Apr. 3, 2025

(54) TEMPLATE-BASED TUNING OF A GENERATIVE MACHINE LEARNING MODEL FOR PERFORMING NATURAL LANGUAGE TASKS

(71) Applicant: Amazon Technologies, Inc., Seattle, WA (US)

(72) Inventors: Zhiheng Huang, Sunnyvale, CA (US); Yue Yang, Redmond, WA (US); Lan Liu, Santa Clara, CA (US); Yuhao Zhang, San Jose, CA (US); Peng Qi, Newcastle, WA (US)

(73) Assignee: Amazon Technologies, Inc., Seattle, WA (US)

(21) Appl. No.: 18/478,811

(22) Filed: Sep. 29, 2023

(51) Int. Cl. G06N 20/00; G06F 40/30; G06F 40/40

(52) U.S. Cl. CPC G06N 20/00; G06F 40/30; G06F 40/40

(57) ABSTRACT

Template-based tuning is performed on a generative machine learning model where a shared template is used to tune the generative machine learning model across multiple natural language tasks. When a natural language request to perform a natural language task is received, portions of a shared template to complete are identified as part of generating a prompt. The generative machine learning model is instructed according to the generated prompt and a response to the request is returned based on a result of the generative machine learning model.

### BACKGROUND

As the technological capacity for organizations to create, track, and retain information continues to grow, a variety of different technologies for managing and storing the rising tide of information have been developed. Different types of data may be stored across many different systems or services. When it is time to locate desired information, the different systems or services storing data may have to be checked in order to obtain relevant data.

### BRIEF DESCRIPTION OF THE DRAWINGS

FIG. 1 illustrates a logical block diagram illustrating template-based tuning of a generative machine learning model for performing natural language tasks, according to some embodiments.

FIG. 2 is a logical block diagram illustrating a provider network offering a natural language generative application service that implements template-based tuning of a generative machine learning model for performing natural language tasks, according to some embodiments.

FIG. 3 is a logical block diagram illustrating interactions to create a natural language generative application at the natural language generative application service, according to some embodiments.

FIG. 4 is a logical block diagram illustrating interactions for adding data repositories, according to some embodiments.

FIG. 5 is a logical block diagram illustrating interactions with a retrieval system of a generative natural language application service, according to some embodiments.

FIG. 6 is a logical block diagram illustrating a data orchestration workflow for handling natural language requests, according to some embodiments.

FIG. 7 is a logical block diagram illustrating template-based tuning of a generative machine learning model, according to some embodiments.

FIG. 8 is a high-level flowchart illustrating various methods and techniques to implement template-based tuning of a generative machine learning model for performing natural language tasks, according to some embodiments.

FIG. 9 is a high-level flowchart illustrating various methods and techniques to implement template-based tuning of a generative machine learning model, according to some embodiments.

FIG. 10 illustrates an example system configured to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques of template-based tuning of a generative machine learning model for performing natural language tasks are described herein. Generative machine learning models refer to machine learning techniques that model different types of data in order to perform various data generative tasks given a prompt. For example, natural language generative machine learning models, such as large language models (LLMs), are one type of generative machine learning model that refer to machine learning techniques applied to model language, which may include natural language (e.g., human speech) and machine-readable language (e.g., programming languages, scripts, code representations, etc.). For generative machine learning models that model language, the generative machine learning models may take language prompts and generate corresponding programming language predictions (which may be referred to as code predictions or code suggestions)

Generative machine learning models that generate language to perform various natural language processing tasks, are a form of machine learning that provides language processing capabilities with wide applicability to a number of different systems, services, or applications. More generally, machine learning refers to a discipline by which computer systems can be trained to recognize patterns through repeated exposure to training data. In unsupervised learning, a self-organizing algorithm learns previously unknown patterns in a data set without any provided labels. In supervised learning, this training data includes an input that is labeled (either automatically, or by a human annotator) with a “ground truth” of the output that corresponds to the input. A portion of the training data set is typically held out of the training process for purposes of evaluating/validating performance of the trained model. The use of a trained model in production is often referred to as “inference,” during which the model receives new data that was not in its training data set and provides an output based on its learned parameters. The training and validation process may be repeated periodically or intermittently, by using new training data to refine previously learned parameters of a production model and deploy a new production model for inference, in order to mitigate degradation of model accuracy over time.

For generative machine learning models, the “inference” may be the output predicted by the generative machine learning model to satisfy a language prompt (e.g., create a summary of a draft financial plan). A prompt may be an instruction and/or input text in one (or more) languages (e.g., in a programming language). Different generative machine learning models may be trained to handle varying types of prompts. Some generative machine learning models may be generally trained across a wide variety of subjects and then later fine-tuned for use in specific applications and subject areas. Fine-tuning refers to further training performed on a given machine learning model that may adapt the parameters of the machine learning model toward specific knowledge areas or tasks through the use of additional training data. For example, an LLM may be trained to recognize patterns in text and generate text predictions across many different scientific areas, literature, transcribed human conversations, and other academic disciplines and then later fine-tuned to be optimized to perform language tasks in a specific area.

Retrieval augmented generation is another technique for adapting generative machine learning models to perform tasks for specific use cases by obtaining relevant data as part of using a generative machine learning model. For example, various data retrieval techniques for identifying and providing relevant data information may be implemented in order to augment the performance of the generative machine learning model.

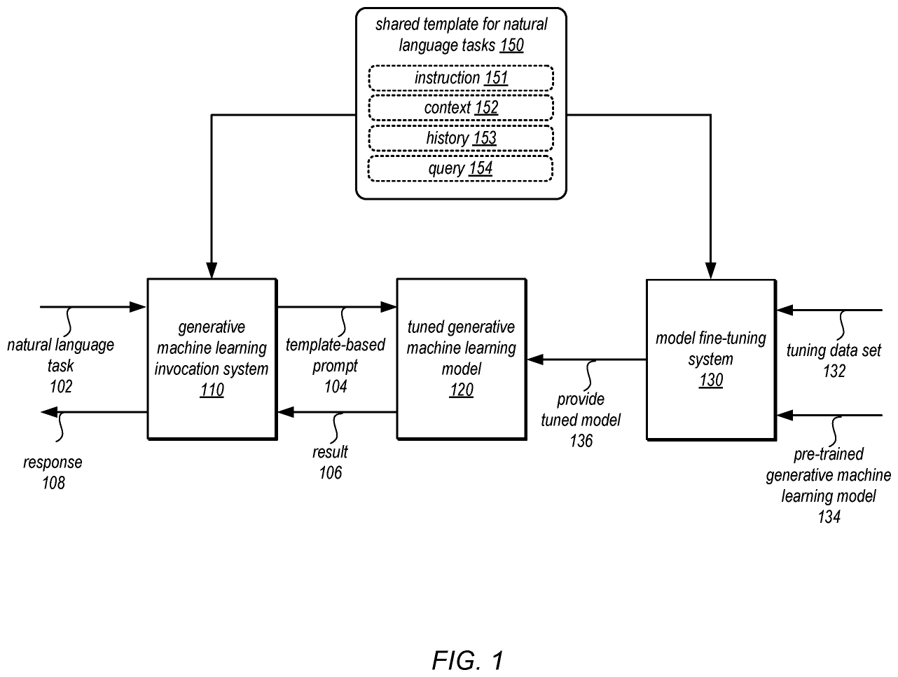

As both tuning and retrieval augmented generation can be used to improve generative machine learning model performance, in various embodiments, techniques that can optimally integrate tuning with retrieval augmented generation may provide even greater performance benefits. For example, as discussed in detail below with regard to FIG. 1, prompt generation for machine learning model may increase the effectiveness of tuning if a shard template is utilized both for tuning techniques and when invoking the tuned generative machine learning model. The shared template may incorporate information obtained as part of a data retrieval so that the fine tuning (and later model invocation) utilizes structured placement retrieved data (e.g., in context field 152 of shared template 150). Moreover, by improving the performance of fine-tuning, a tuned generative machine learning model may provide better and more accurate results, which increases the performance quality of various computing systems, services, and applications that rely upon the better tuned generative machine learning model to operate.

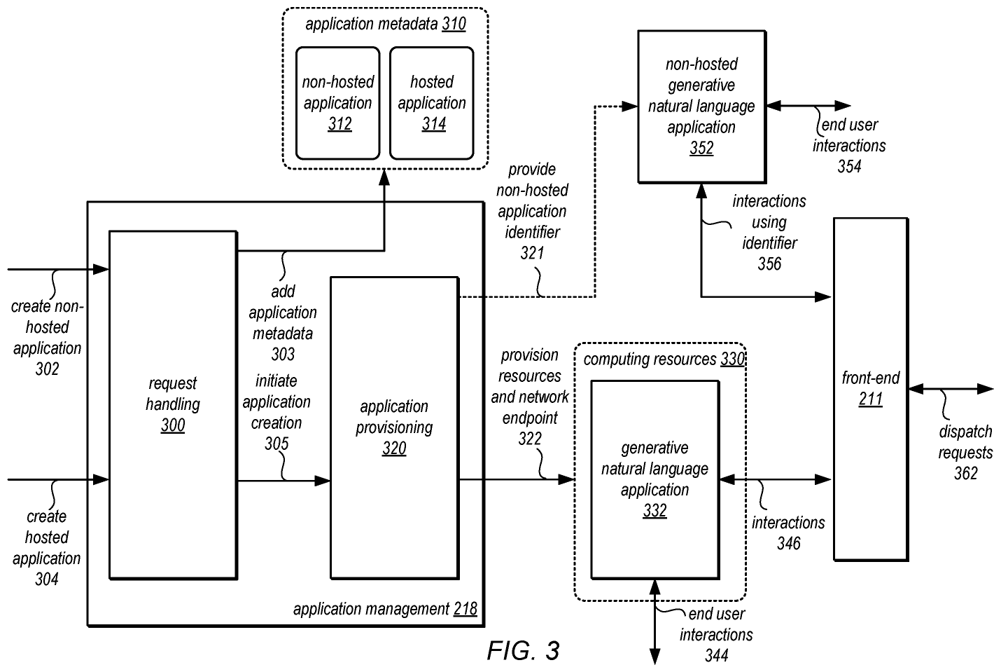

FIG. 1 illustrates a logical block diagram illustrating template-based tuning of a generative machine learning model for performing natural language tasks, according to some embodiments. Generative machine learning system 110 may be a standalone system or service implemented as part of a provider network (e.g., natural language generative application service (like service 210)) and/or any other system that makes use of generative machine learning techniques to invoke a tuned generative machine learning model 120. Natural language task 102 may be received (e.g., a question, instruction, or combination of both). Natural language task 102 may be associated with an natural language generative application, which may perform various natural language tasks for users using associated data repository(ies) (as discussed below with regard to FIGS. 3-6. In this way, natural language processing tasks can be performed in a relevant, secure, and verifiable fashion using particular data sets of interest to an application.

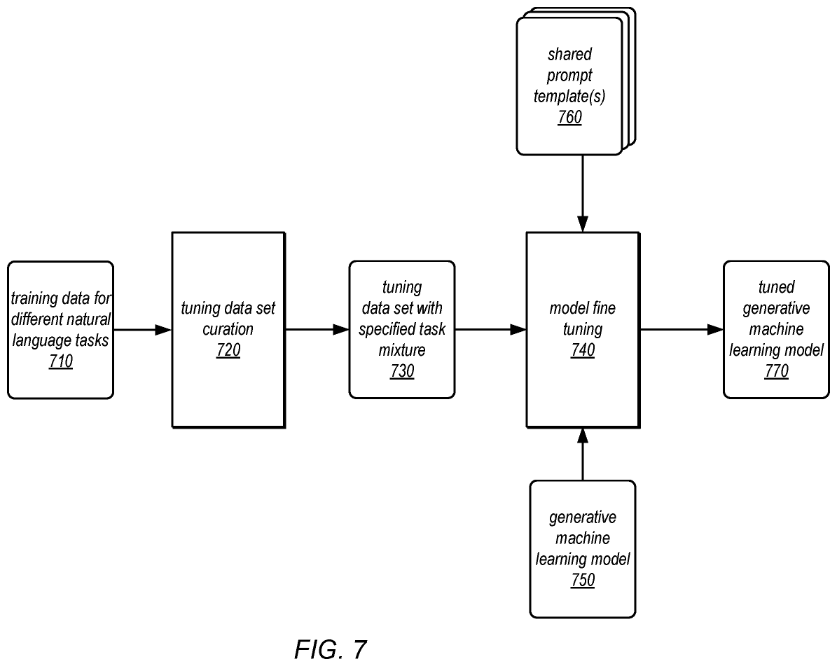

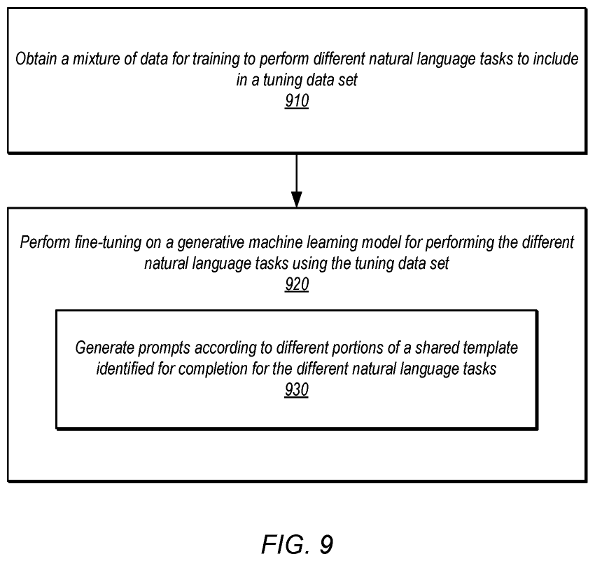

Generative machine learning system 110 may use tuned generative machine learning model 120. Although not illustrated, data may be retrieved to augment the context of performing natural language task 102. Tuned generative machine learning model 120 may be a fine-tuned generative model. For example, as indicated at 130, a model fine-tuning system 130 (which may be implemented with or separate from generative machine learning system 110) may receive a pre-trained generative machine learning model 134 and tuning data set 132 and perform fine tuning, as discussed in detail below with regard to FIGS. 7 and 9. As part of model fine tuning, shared template for natural language tasks 150 may be used. Different portions of the shared template 150 may be completed for different tasks. Such portions may include, but are not limited to, instruction 151, context 152, history 153, and query 154, which may store portions of the task 102, context (e.g., retrieved data), past conversation history, and question. Not all fields of a template may be completed for each prompt as different tasks may have different characteristics. Once tuned, the model may be provided to generative machine learning system 110, as indicated at 136. These techniques may allow for multiple different tuned generative machine learning models to be generated and provided. In some embodiments, a natural language task can be associated with a selected one (out of multiple) tuned generative machine learning models.

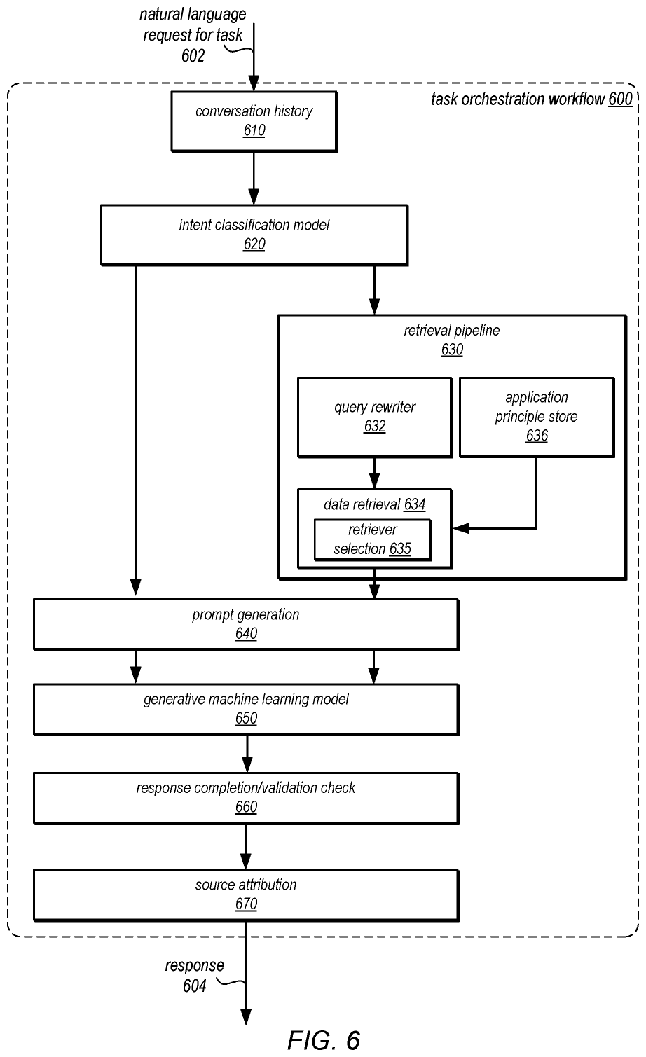

Shared template 150 may also be used at generative machine learning system 110 in order to identify and complete portions of the template to generate a prompt. For example, as discussed below with regard to FIG. 6, an intent classification may be determined in order to identify which portions of the shared template 150 should be completed (e.g., portions mapped to instruction, question, keyword query, or chitchat classifications). The template-based prompt 104 may then be used to obtain a result 106 from tuned generative machine learning model 120. Generative machine learning system 110 may return a response 108, which may be based on result 106 (and potentially other post result processing, such as source attribution and result validation).

Please note that the previous description is a logical illustration and thus is not to be construed as limiting as to the implementation. Different combinations or implementations may be implemented in various embodiments.

This specification begins with a general description of a provider network that implements a generative natural language application service that template-based tuning of a generative machine learning model for performing natural language tasks. Then various examples of distributed orchestration of natural language tasks using a generative machine learning model including different components, or arrangements of components that may be employed as part of implementing the service are discussed. A number of different methods and techniques to implement template-based tuning of a generative machine learning model for performing natural language tasks are then discussed, some of which are illustrated in accompanying flowcharts. Finally, a description of an example computing system upon which the various components, modules, systems, devices, and/or nodes may be implemented is provided. Various examples are provided throughout the specification.

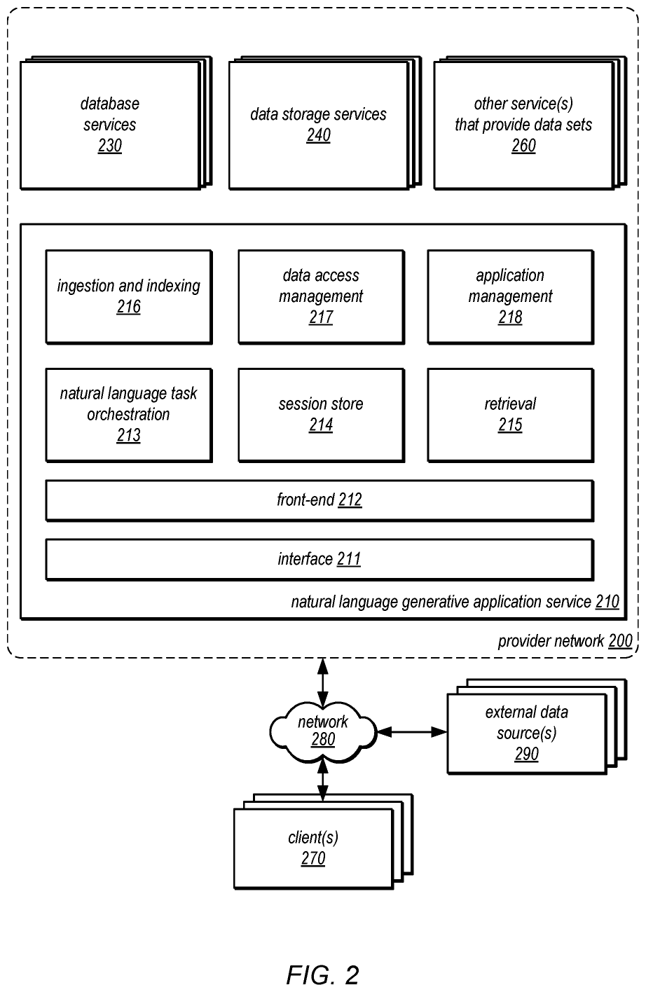

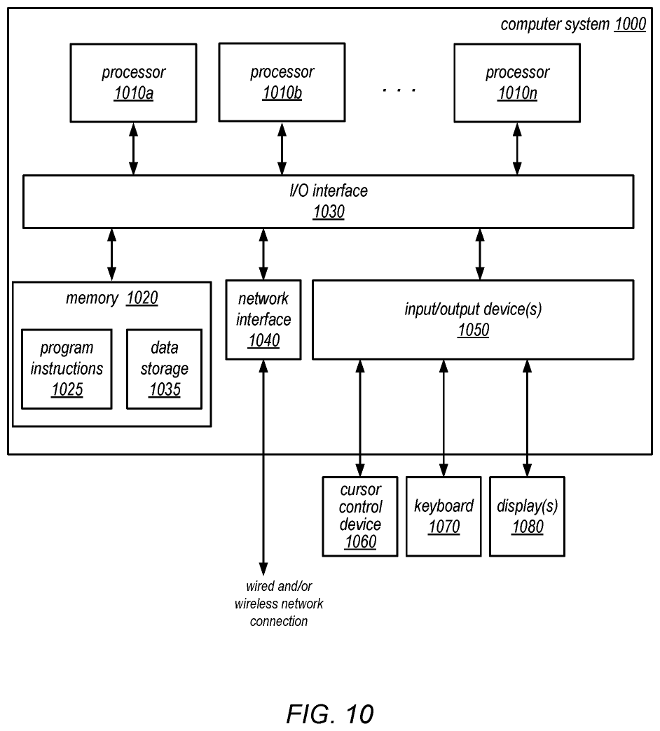

FIG. 2 is a logical block diagram illustrating a provider network offering a natural language generative application service that implements intent classification for executing a retrieval augmented generation pipeline for natural language tasks using a generative machine learning model, according to some embodiments. Provider network 200 may be a private or closed system or may be set up by an entity such as a company or a public sector organization to provide one or more services (such as various types of cloud-based storage) accessible via the Internet and/or other networks to clients 270, in some embodiments. Provider network 200 may be implemented in a single location or may include numerous data centers hosting various resource pools, such as collections of physical and/or virtualized computer servers, storage devices, networking equipment and the like (e.g., computing system 1000 described below with regard to FIG. 10), needed to implement and distribute the infrastructure and services offered by the provider network 200. In some embodiments, provider network 200 may implement various computing systems, platforms, resources, or services, such as a natural language generative application service 210, compute services, database service(s) 230, (e.g., relational or non-relational (NoSQL) database query engines, map reduce processing, data flow processing, and/or other large scale data processing techniques), data storage service(s) 240, (e.g., an object storage service, block-based storage service, or data storage service that may store different types of data for centralized access), data stream and/or event services, and other services (any other type of network based services (which may include various other types of storage, processing, analysis, communication, event handling, visualization, and security services not illustrated), including other service(s) 260 that provide or generate data sets for access by natural language generative application service 210.

In various embodiments, the components illustrated in FIG. 2 may be implemented directly within computer hardware, as instructions directly or indirectly executable by computer hardware (e.g., a microprocessor or computer system), or using a combination of these techniques. For example, the components of FIG. 2 may be implemented by a system that includes a number of computing nodes (or simply, nodes), each of which may be similar to the computer system embodiment illustrated in FIG. 10 and described below. In various embodiments, the functionality of a given system or service component (e.g., a component of data storage service 230) may be implemented by a particular node or may be distributed across several nodes. In some embodiments, a given node may implement the functionality of more than one service system component (e.g., more than one data store component).

In various embodiments, natural language generative application service 210 may provide a scalable, serverless, and machine-learning powered service to create or support generative natural language applications using data specific to the application, such as data stored in database services 230, data storage services 240, or other services 260. Natural language generative application service 210 may enables users (e.g., enterprise customers) to deploy a generative AI-powered “expert” in minutes. For example, users (e.g., enterprise employees or agents) can ask complex questions via applications that operate on enterprise data, get comprehensive answers and execute actions on their enterprise applications in a unified, intuitive experience powered by generative AI.

Natural language generative application service 210 easily connects to a variety of different systems, services, and applications, both hosted internal to provider network 200 and external to provider network 200 (e.g., other provider network/public cloud services or on-premise/privately hosted systems). Once connected, natural language generative application service 210 allows users to ask complex questions and execute actions on these systems using natural language (e.g., human speech commands). For example, a sales agent can ask the generative application to compare the various credit card offers and recommend a card with the best travel points for their customer and natural language generative applications service 210 would support the features to provide a recommendation and the reason for its choice along with references to the data sources for this recommendation. In some scenarios, a user can use the generative application to create a case summary and add it to a customer relationship management (CRM) system.

Natural language generative application service 210 may implement security layers that check user permissions to prevent unauthorized access to enterprise systems thereby ensuring users only see information and perform actions they are entitled to. Natural language generative application service 210 implements guardrails to protect against and avoids incorrect or erroneous statements or other generated results (sometimes called hallucinations) by limiting the responses to data in the enterprise and builds trust by providing citations and references to the sources used to generate the answers. Natural language generative application service 210 may offer an intuitive user interface to create and deploy an enterprise-grade application to users in minutes without requiring generative machine learning domain expertise.

For example, enterprises are struggling to provide new generative AI-powered experiences that their users expect while interacting with enterprise systems. Users may need to switch across multiple fragmented systems like internal wiki, various data share sites, communication sites or messaging services in order to find information because they cannot get comprehensive answers collated from ideas contained in multiple pieces of content. Moreover, users are unable to ask probing follow-up questions or perform comparative analysis on the content to understand it better. When users need to take any follow-up actions, users then need go through multiple platforms like CRM systems, ticketing systems and other enterprise applications to take the action.

Recent advancements in generative AI powered by machine learning models trained to generate content (referred to as generative machine learning models), such as generative language models, like Large Language Models (LLMs), have opened up possibilities to build intuitive expert-like experiences. However, these generative models have limitations as they are not knowledgeable about enterprise data and their knowledge is not up-to-date. Generative models also hallucinate and there is no way for end users to fact-check the responses. Additionally, enterprises need to ensure that users do not get answers from content that they do not have access to. Enterprises may also need to build a conversational application and deploy it for their users. This makes it hard to adopt the new generative AI technologies for enterprise use cases. Lack of unified, intuitive experiences for the enterprise leads to poor knowledge sharing among the users, lower rate of self-service, and loss of productivity across the company.

With natural language generative application service 210, enterprises (and other service users) utilize the various features of natural language generative application service 210 to overcome the technical challenges standing in the way of enterprises to make use of generative AI. Natural language generative application service 210 allows enterprises to easily tap into the power of AI technologies, including generative AI, to transform how their users interact with their enterprise applications in a secure way. Natural language generative application service 210 moves beyond the traditional fragmented experience of navigating multiple systems to a single, unified expert-like experience. Using an intuitive interface elements (e.g., a simple point-and-click admin interface), application creators (e.g., for enterprises) can sync with enterprise systems. Users of the generative applications benefit from capabilities like generative answers from multiple documents, answers from knowledge embedded in the model, comparative analysis, content summarization, math and reasoning, text generation and ability to execute actions on enterprise apps. Natural language generative application service 210 may support requests to find information and execute follow-up actions (e.g., “find me policy options for this client and attach a summary to client notes in a CRM system”). Natural language generative application service 210 uses enterprise content to generate answers thus minimizing hallucinations and providing up-to-date information. To ensure trust and safety for the users, Natural language generative application service 210 weaves in human-like citations, references, and attachments for source documents in its response. Natural language generative application service 210 manages enterprise access and access control list (ACL) permissions. When the user asks a question to natural language generative application service 210, natural language generative application service 210 analyzes the data in the enterprise systems and generates responses only from the content that the user has access to. Natural language generative application service 210 also provides a pre-built conversational application that can be easily deployed for end users in minutes speeding up the time to value for application creators. The unified and intuitive experience provided by natural language generative application service 210 improves productivity and knowledge sharing for enterprises and enhances self-service for end users.

In various embodiments, application creators can deploy generative applications that can utilize natural language generative application service 210 in their enterprise in minutes. For example, in a console or other graphical user interface, creators can quickly connect their enterprise systems to natural language generative application service 210. Natural language generative application service 210 provides a wide range of built-in data connectors to different data sources to associate them as data repositories for a generative application and supports data retrievers, which find relevant data (e.g., documents or other non-natural language data, such as image data, numerical data, audio or video data) to feed into a generative machine learning model (e.g., an LLM). Natural language generative application service 210 also supports actions for enterprise systems such as updating a customer record in a database or creating a ticket in an issue management system so that users can execute actions in those applications using natural language commands. Next, application creators can connect their generative applications with their identity providers (e.g., both internal to or external to provider network 200)., etc. Finally, application creators can deploy the pre-built conversational application to their end users.

Natural language generative application service 210 may support interactions through a generative application created (and in some embodiments hosted by natural language generative application service 210) in order to perform various tasks, which may be specified in natural language request. Features of natural language generative application service 210 to support these interactions may include question answering for enterprise data. For instance, natural language generative application service 210 can process questions from end users and returns generative responses using information from various secure enterprise data sources. Natural language generative application service 210 can continue the conversation with the user in the context of the active session or start with a new one. Natural language generative application service 210 will support question answering on both structured and unstructured data sources. Application creators (e.g., which may be enterprise administrators) can choose if they want to limit answers from enterprise content or leverage the knowledge of the generative model to answer queries.

Another example feature of natural language generative application service 210 to support interactions may be security. Natural language generative application service 210 provides ACL support across private data (e.g., enterprise data) and the application-level security for enterprise systems. Natural language generative application service 210 may generate responses that are only based on content that an end user has access to. Natural language generative application service 210 may presents references and other summary information from the sources (e.g., documents) which were used to generate the response for the end user so that the user can use that for fact checking. Follow-up actions suggested by natural language generative application service 210 to the user will only execute actions on applications that the user has access to (e.g., database systems, CRM systems, and so on that the user has access to).

Another example feature of natural language generative application service 210 to support interactions may be actions. Natural language generative application service 210 enables end users to perform actions on various applications like email, messaging, posting or other communication or data sharing applications using natural language commands. For example, an end user can ask natural language generative application service 210 to update an opportunity in a CRM system or create a ticket in a ticketing system.

Another example feature of natural language generative application service 210 to support interactions is summarization. End users can also ask for a summary of the content in their chat.

Another example feature of natural language generative application service 210 to support interactions is built-in data connectors. Natural language generative application service 210 natively supports document and other data retrievers for many different data storage systems, data search systems, database systems, or any other data repositories, including support for ACLs for those systems. The connectors may eliminate the heavy lifting involved in crawling data sources, extracting text content from files, and making it available for search.

Another example feature of natural language generative application service 210 to support interactions may be usage analytics. Natural language generative application service 210 allows application creators (e.g., admins) to analyze end user engagement metrics including the number of queries, number of sessions, queries per session, and popular queries. In this way, an application can be updated or modified based on the usage analytics.

Another example feature of natural language generative application service 210 to support interactions is personalization. Natural language generative application service 210 leverages an end user's context such as role, location, etc. and learns from past interactions such as past searches as well as thumbs up/thumbs down feedback received from users to provide a personalized experience.

Natural language generative application service 210 may support various features to ingest, index, and/or retrieve relevant data from associated data repositories for a generative application. Natural language generative application service 210 features that can connect and ingest data from different data sources. Once the data sources are connected, natural language generative application service 210 will process data from these content sources and be ready to be deployed in minutes. However, if an application creator already has content in a retriever like OpenSearch or other index, then these retrievers can easily be integrate with natural language generative application service 210.

As noted above, generative machine learning models can sometimes create seemingly good but factually incorrect or otherwise erroneous answers called hallucinations. In addition, it is possible that generative machine learning models pick up inappropriate content because they are trained on large public data sets. These risks can undermine the accuracy and trustworthiness for applications. Natural language generative application service 210 addresses these issues with multiple capabilities. Natural language generative application service 210 combines generative machine learning models with application-specific data retrieval to provide question answering functionality. Natural language generative application service 210 first uses a retriever to find relevant data for a request from the associated data repositories and then feeds portions from the top relevant data to a generative machine learning model to get a synthesized response that is relevant to application creator (e.g., enterprise) content. In addition, natural language generative application service 210 provides citations and references to the enterprise documents that were used to generate the responses so that end users can verify the accuracy of the answer. Natural language generative application service 210 also leverages built-in prompt and response classifiers to detect inappropriate content such as swearing, insults, and profanity.

Natural language generative application service 210 provides various interface elements and features, including APIs and UI components (e.g., code snippets or libraries that encapsulate the natural language generative application service 210 functionality without defining the specific style of the user interface) for application creators who want to integrate natural language generative application service 210 with their own generative AI-powered applications. Using these APIs and headless components, application creators can embed natural language generative application service 210 features into their own applications.

Natural language generative application service 210 provides many customization options for application creators, including but not limited to:
(1) Tuning the response styles such as whether answers should be short vs. long or generative vs. extractive.
(2) Configuring “featured answers” for specific queries.
(3) Customizing natural language generative application service 210 to prioritize results based on attributes such as content source, popularity, freshness, and other content metadata.
(4) Creating a custom thesaurus to help natural language generative application service 210 understand company specific jargon. For example, natural language generative application service 210 can be trained to know that MBP means Mobile Banking Platform.
(5) Using custom document enrichment to augment the content during ingestion to make them more meaningful.
(6) Ability to add custom actions for in-house applications to enable natural language generative application service 210 to execute on them.

There may be scenarios in which natural language generative application service 210 cannot find or cannot generate a desired result (e.g., an answer to a particular question). In such scenarios, natural language generative application service 210 will respond that it could not find the answer and will return a list of documents or other data that may contain information related to the question asked.

Natural language generative application service 210 supports various creation user interfaces, including programmatic, API or software development kit (SDK), and/or graphical user interfaces, such as a hosted web-console. For example, a web-console of natural language generative application service 210 may provide an easy way to get started. An application creator can point natural language generative application service 210 to content sources and use the experience builder to quickly deploy a pre-built user interface for end users. An application creator can also apply customization such as response tuning, custom document enrichment, and custom synonyms, to further improve answer accuracy, as noted above. Natural language generative application service 210 can also be integrated with non-hosted applications using APIs.

Natural language generative application service 210 natural language capabilities enable it to understand any business domain or specialty. However, for application specific vocabulary (e.g., specific to a particular enterprise), application creators can use natural language generative application service 210's custom synonyms feature to tune natural language generative application service 210 so that it can recognize those words.

Natural language generative application service 210 may provide support to access various types of data files and formats, including but not limited to, PDF, HTML, slide presentation files, word processing files, spreadsheet files, Javascript Object Notation (JSON), Comma Separated Value (CSV), Rich Text Files (RTFs), plain text, audio/video, images and scanned documents. Natural language generative application service 210 may support many different human languages for interacting performing natural language tasks.

Natural language generative application service 210 may securely store application data and uses it only for the purpose of providing the service to the application's end-users. The data may be encrypted using service-provided keys or application creator provided keys.

Natural language generative application service 210 may implement front-end 211, in some embodiments. Front-end 211 may support various types of programmatic (e.g., Application Programming Interfaces (APIs)), command line, and/or graphical user interfaces to support the management of data sets for analysis, request, configure, and/or otherwise obtain new or existing analysis, and/or perform natural language queries, as discussed below. Front-end 211 may be a service that an application creator (or application owner) will use to configure and build custom applications (e.g., for generative AI-powered conversation). For example, front-end 211 may support HTTPS/2 for streaming use cases and fall back to HTTPS/1.1 for non-streaming use cases, in some embodiments. In some embodiments, front-end 211 may have browser support for API, with web-socket support for the streaming interface. In various embodiments, front-end 211 may implement throttling, metering, ensuring authentication and authorization.

Front-end 211 may dispatch requests (and/or proxy for) downstream services of natural language generative application services (e.g., control plane 212, natural language task orchestration 213, session store 214, retrieval 215, ingestion and indexing 216, data access management 217, and application management 218). For example, front-end 211 may dispatch requests to control plane 212 for setting up the top level resources necessary for generative applications/accounts, to application management 218 to allow configuration of the app, to retrieval 215 to allow configuring of retrieval sources against the generative application, to session store 214 to get conversational history (for conversational history API, to natural language task orchestration 213 for the generative requests.

Natural language generative application service 210 may implement control plane 212, in some embodiments. Control plane 212 may be a service which will store and manage the top level account for a generative application (or multiple generative applications that may be created under an account). Control plane 212 may also be a single point service for handling data protection regulation (e.g., GDPR), resource identification and tagging from other provider network 200 services, and requests for operations such as deletion of top level resources. Control plane 212 may orchestrate the actions across other services of natural language generative application service 210, such as application management service 217 and retrieval 215.

Natural language generative application service 210 may implement ingestion and indexing 216, in some embodiments. Ingestion and indexing 216 service may allow application creators to identify and index data for association as a data repository for a generative application Ingestion and indexing 215 may index documents to a service index (e.g., via an API call). Ingestion and indexing 218 may be service that stores documents into a service index for retrieval as part of performing natural language tasks. In some embodiments, ingestion and indexing 2158 abstracts the underlying storage and type and may include a model invocation during indexing and retrieval operation. The model call may be to generate embedding vectors before the data is indexed and also against the data (e.g., query text) during retrieval invocation.

Natural language generative application service 210 may implement data access management 217, in some embodiments. As discussed in detail below with regard to FIG. 7, data access management 217 may create an application principal store 750 that can utilize information obtained from data sources to generate mappings between different data sources and local user identities, which can then be mapped to an end user identity for an application. Similar techniques can be applied for groups. In this way, data access management 217 can provide or support access controls to specific data in data repositories associated with an application that limits data obtained from those data repositories in accordance with the data that should be made visible to or available to an end-user of a generative application.

Natural language generative application service 210 may implement application management 218, in some embodiments. In various embodiments, natural application management 218 may support creation and hosting of a generative application that will be available to end users like a SAAS (Software as a service) available, as a hosting service or an application that is published to an endpoint, as discussed in detail below with regard to FIG. 3. For example, application management 218 may implement distribution of static components, a web service which will accepts network requests (e.g., HTTP 1.1 communication protocol) for transferring application data like conversation history, user identity, and so on, a Web socket service to provide bi-directional streaming and chat conversation capabilities to a browser, and a metadata store which will allow the application to get runtime information such as domain id. Natural language generative application service 210 may support web browser generative applications and support authentication to external identity providers directly via Security Assertion Markup Language (SAML) Single Sign On (SSO) protocol and/or other SSO protocols. Natural language generative application service 210 may be implemented so that hosted generative applications are a proxy to frontend 211 of natural language generative application service 210.

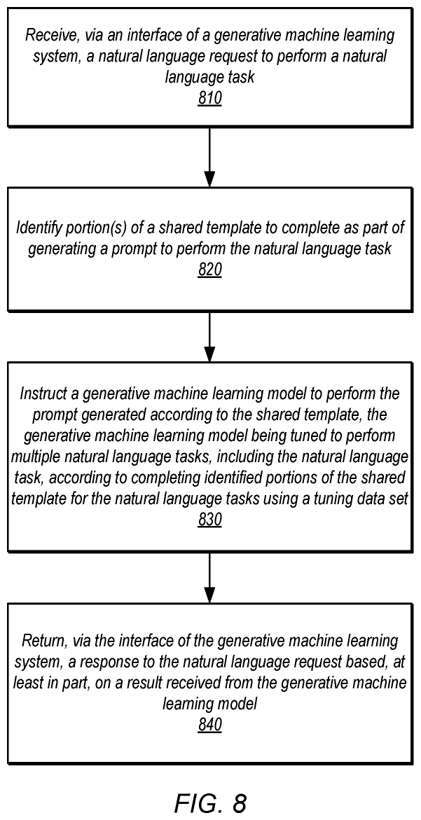

Natural language generative application service 210 may implement natural language task orchestration 213, in some embodiments. Natural language task orchestration 213 may execute workflows to perform natural language tasks received as natural language requests, as discussed above and in detail below with regard to FIG. 8. For example, natural language task orchestration may include various sub-components, systems, or microservices that can, among other operations, take request input along with information such as user id and filtering criteria and running them through a orchestration process, that includes, but is not limited to, ensuring that the query input is free from profanity, getting the conversation context from session store, query re-writing and generation, retrieving one or more results from retrieval service, sending the information through to a generative machine learning model, and sending the information through some response classifier to ensure that response is free from bias, profanity and slur.

Natural language generative application service 210 may implement session store 214, in some embodiments. Session store 214 may be responsible for ensuring that the context in a conversation is maintained (e.g., even if the socket connection is closed by the user). Session store 214 may also providing the data for the conversation history (as discussed below with regard to FIG. 6). Session store 214 may also provide the data for analytics (e.g., queries per session, number of sessions active at a given time, and so on as discussed above). Session store 214 may use a session id and message id to track each conversation and its associated thread associated with each user id (which may be specific to a particular end user of a generative application, which may have multiple different users).

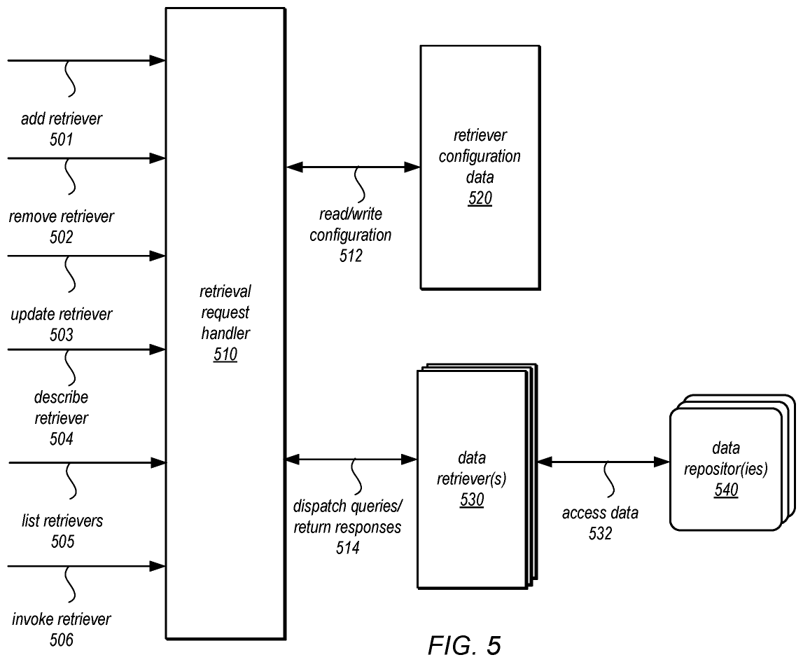

Natural language generative application service 210 may implement retrieval 215, in some embodiments. Retrieval service 215 may support data retrieval from retrieval sources, as discussed in detail below with regard to FIG. 5. For example, retrieval service 215 may implement a metadata store (e.g., retriever configuration data 520 discussed below), which may be used to store all the metadata associated with the specific retriever. This can be information related to access roles or other credentials, such as an identity and access management (IAM) role, virtual private networking information (to talk to a data source in a virtual private network). Retrieval service 215 will fetch the data from the underlying retrieval source, an associated data repository. In some embodiments, retrieval service 215 may have built-in integration with a data repository (e.g., a pre-built data retriever) or may support obtaining and applying information from an application creator to specify parameters/query information in order to build a data retriever to obtain data.

In various embodiments, database services 230 may be various types of data processing services that perform general or specialized data processing functions (e.g., analytics, big data querying, time-series data, graph data, document data, relational data, structured data, or any other type of data processing operation) over data that is stored across multiple storage locations, in some embodiments. For example, in at least some embodiments, database services 210 may include various types of database services (e.g., relational) for storing, querying, and updating data. Such services may be enterprise-class database systems that are scalable and extensible. Queries may be directed to a database in database service(s) 230 that is distributed across multiple physical resources, as discussed below, and the database system may be scaled up or down on an as needed basis, in some embodiments. The database system may work effectively with database schemas of various types and/or organizations, in different embodiments. In some embodiments, clients/subscribers may submit queries or other requests (e.g., requests to add data) in a number of ways, e.g., interactively via an SQL interface to the database system or via Application Programming Interfaces (APIs). In other embodiments, external applications and programs may submit queries using Open Database Connectivity (ODBC) and/or Java Database Connectivity (JDBC) driver interfaces to the database system.

In some embodiments, database services 220 may be various types of data processing services to perform different functions (e.g., query or other processing engines to perform functions such as anomaly detection, machine learning, data lookup, or any other type of data processing operation). For example, in at least some embodiments, database services 230 may include a map reduce service that creates clusters of processing nodes that implement map reduce functionality over data stored in one of data storage services 240. Various other distributed processing architectures and techniques may be implemented by database services 230 (e.g., grid computing, sharding, distributed hashing, etc.). Note that in some embodiments, data processing operations may be implemented as part of data storage service(s) 230 (e.g., query engines processing requests for specified data).

Data storage service(s) 240 may implement different types of data stores for storing, accessing, and managing data on behalf of clients 270 as a network-based service that enables clients 270 to operate a data storage system in a cloud or network computing environment. For example, one data storage service 230 may be implemented as a centralized data store so that other data storage services may access data stored in the centralized data store for processing and or storing within the other data storage services, in some embodiments. Such a data storage service 240 may be implemented as an object-based data store, and may provide storage and access to various kinds of object or file data stores for putting, updating, and getting various types, sizes, or collections of data objects or files. Such data storage service(s) 230 may be accessed via programmatic interfaces (e.g., APIs) or graphical user interfaces. A data storage service 240 may provide virtual block-based storage for maintaining data as part of data volumes that can be mounted or accessed similar to local block-based storage devices (e.g., hard disk drives, solid state drives, etc.) and may be accessed utilizing block-based data storage protocols or interfaces, such as internet small computer interface (iSCSI).

In various embodiments, data stream and/or event services may provide resources to ingest, buffer, and process streaming data in real-time, which may be a source of data repositories. In some embodiments, data stream and/or event services may act as an event bus or other communications/notifications for event driven systems or services (e.g., events that occur on provider network 200 services and/or on-premise systems or applications).

Generally speaking, clients 270 may encompass any type of client configurable to submit network-based requests to provider network 200 via network 280, including requests for materialized view management platform 210 (e.g., a request to create a generative application at natural language generative application service). For example, a given client 270 may include a suitable version of a web browser, or may include a plug-in module or other type of code module that may execute as an extension to or within an execution environment provided by a web browser. Alternatively, a client 270 may encompass an application such as a generative application (or user interface thereof), in provider network 200 to implement various features, systems, or applications. (e.g., to use natural language generative application service 210 APIs to send natural language requests to perform different tasks (e.g., question answering, summarization, or various other features as discussed above). In some embodiments, such an application may include sufficient protocol support (e.g., for a suitable version of Hypertext Transfer Protocol (HTTP)) for generating and processing network-based services requests without necessarily implementing full browser support for all types of network-based data. That is, client 270 may be an application may interact directly with provider network 200. In some embodiments, client 270 may generate network-based services requests according to a Representational State Transfer (REST)-style network-based services architecture, a document- or message-based network-based services architecture, or another suitable network-based services architecture.

In some embodiments, a client 270 may provide access to provider network 200 to other applications in a manner that is transparent to those applications. For example, client 270 may integrate with an operating system or file system to provide storage on one of data storage service(s) 240 (e.g., a block-based storage service). However, the operating system or file system may present a different storage interface to applications, such as a conventional file system hierarchy of files, directories and/or folders. In such an embodiment, applications may not need to be modified to make use of the storage system service model. Instead, the details of interfacing to the data storage service(s) 240 may be coordinated by client 270 and the operating system or file system on behalf of applications executing within the operating system environment.

Clients 270 may convey network-based services requests (e.g., natural language queries) to and receive responses from provider network 200 via network 280. In various embodiments, network 280 may encompass any suitable combination of networking hardware and protocols necessary to establish network-based-based communications between clients 270 and provider network 200. For example, network 280 may generally encompass the various telecommunications networks and service providers that collectively implement the Internet. Network 280 may also include private networks such as local area networks (LANs) or wide area networks (WANs) as well as public or private wireless networks. For example, both a given client 270 and provider network 200 may be respectively provisioned within enterprises having their own internal networks. In such an embodiment, network 280 may include the hardware (e.g., modems, routers, switches, load balancers, proxy servers, etc.) and software (e.g., protocol stacks, accounting software, firewall/security software, etc.) necessary to establish a networking link between given client 270 and the Internet as well as between the Internet and provider network 200. It is noted that in some embodiments, clients 270 may communicate with provider network 200 using a private network rather than the public Internet.

As noted above, natural language generative application service 210 may support communications with external data sources 290 over network 280 in order to obtain data for performing various natural language tasks.

FIG. 3 is a logical block diagram illustrating interactions to create a natural language generative application at the natural language generative application service, according to some embodiments. Application management 218 may support various requests to create generative applications for performing natural language tasks using the features of natural language generative application service 210. For example, application management 218 may support various features for generative applications to create Web applications or other hosted applications. Non-hosted applications may still be created to manage the various back-end features via requests to front-end 211 to data, security, task orchestration, and other features for a generative application even when the generative application itself is not hosted. Application management 218 may support the creation of generative applications that can, for example, add any identity provider. End users of the generative application should then be able to login with the configured identity provider. In some embodiments, application management 218 may support creation of a custom header on a hosted generative application (e.g., a custom header for a Web application). Application management 218 may support adding a custom prefix to URLs or other network identifiers that are provided to access the hosted generative application. A created generative application may support for both hosted and non-hosted applications, interactions to chat/converse using application-associated data repositories and a service hosted generative machine learning model.

A request to create a non-hosted application 302 may be received. The creation request may include many of the aforementioned configuration features or parameters, such as including an identity provider, implement or enable various analytics collection, associated or specify various associated data repositories, enable/specify various custom features (e.g., actions, style, etc. as discussed above). Request handling 300 may be invoked by control plane 212 which may be invoked by front-end 211, not illustrated) to perform the request and create in application metadata 310 configuration information for non-hosted application 312. Various features of a non-hosted application can be changed in subsequent requests (not illustrated), such as adding or removing data repositories, adding, modifying, or removing custom features, or various other features of the non-hosted application. For a non-hosted application, application provisioning 320 may still allocate application identifiers and/or other information, as indicated at 321. When non-hosted generative language application 352 invokes natural language generative application service 210 via front-end 211 to perform different tasks (e.g., responsive to end user interactions 354) using the provided identifier, as indicated at 356. Although not illustrated, interactions with an identity provider may be performed prior to performing interactions 356 (e.g., by application 352 interacting with an identity provider system/service directly). The end user identity, having been determined by the identity provider (e.g., using sign-on or other end user identification procedure), may be included to information interactions 356 to be specific to the identified end user.

For request to create a hosted application 304, request handling 300 may initiate application creation 305, application provisioning 320 may provision computing resources 330 and a network endpoint for accessing the generative natural language application 332 (which may be configured according to various options supported by application management 218) in addition to adding hosted application metadata 314. For example, the creation request 304 may include many of the aforementioned configuration features or parameters, such as including an identity provider, implement or enable various analytics collection, associated or specify various associated data repositories, enable/specify various custom features (e.g., actions, style, etc. as discussed above). Various features of a non-hosted application can be changed in subsequent requests (not illustrated), such as adding or removing data repositories, adding, modifying, or removing custom features, or various other features of the hosted application. Application provisioning 320 may obtain (e.g., from computing service provider of provider network 200), computing resources 330 (e.g., virtual computing resources to serve as a host system) and build a generative natural language application 332 according to the provided configuration features. For example, different software components corresponding to the different selected features can be obtained and integrated based on the application specific information (e.g., identified data repositories, identified data retrievers, identity provider, and so on). Then an executable form (e.g., compiled, assembled, or otherwise built form of the generative application may be installed on the provisioned computing resources as generative natural language application 332. A network endpoint (e.g., a network address, such as a URL), may be provided so that end-users can access generative natural language application 332.

Once created, generative natural language application 332 may be ready to accept end user requests 344 and interact 346 with natural language generative application service via front-end 211. An example interaction flow is described below. An end user visits the hosted generative application (e.g., web app) network endpoint for the first time and gets directed to the login page of the configured identity provider, where the end user enters their username and password. Upon successful authentication, the end user is directed to obtain access credentials for generative natural language application 332 (e.g., using the SAMLRedirect API, where the identity provider provides the SAMLAssertion certification, then calling the STS (Security Token Service) assumeRoleWithSAML using the SAMLAssertion to obtain sigV4 credentials (AccessKey, SecretKey). The obtained credentials may be valid for a period of time (e.g., 1 hour) allowing the end user access to generative natural language application 332. The end user is then directed to the home page for final authentication and credential (e.g., using cookies or other session preserving information). An authentication token may be obtained and used to establish a connection for interactive features (e.g., a WebSocket chat connection to front-end 211) and event streaming by signing all calls with these credentials and store them in browser memory for further use until they expire.

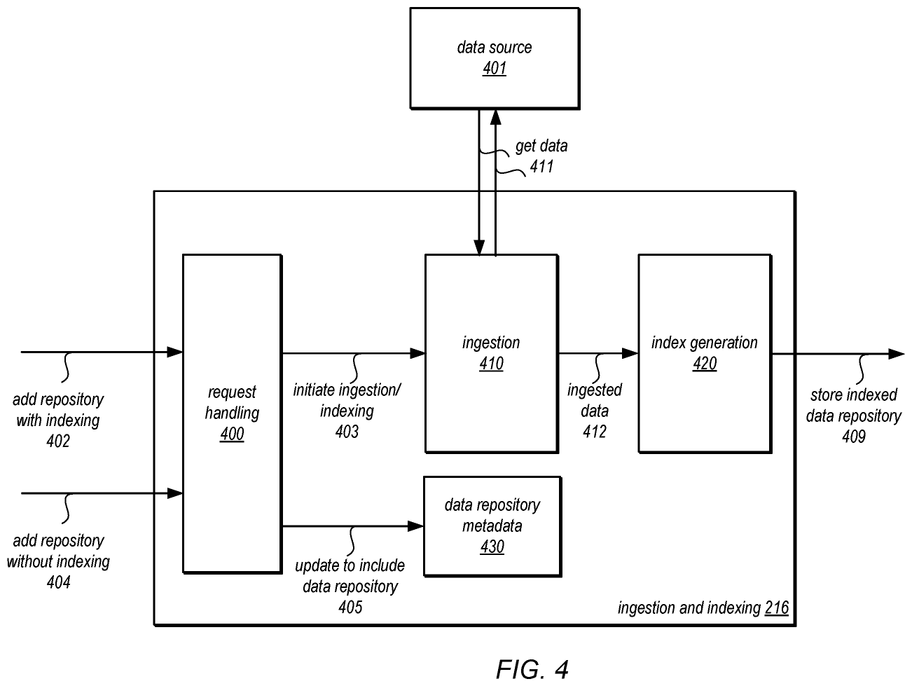

FIG. 4 is a logical block diagram illustrating interactions for adding data repositories, according to some embodiments. A request to add a repository with index 402 may cause request handling 400 to initiate ingestion 410 to get 411 data from data source 401 and provide ingested data 412 to index generation 420 which may generate the index according to a known schema and store 409 the indexed data repository. The data repository metadata 430 may be updated 405 to add the new repository.

For example, ingestion 410 may implement different connectors (e.g., software components that interact with or are deployed as agents) on a data source 401. Data source 401, may be various types of data storage, processing, messaging, streaming, or other information sources, internal to or external to provider network 200, as noted above. Different connectors may implemented different respective file interpreters, parsers, crawlers, or other features that can interpret and obtain information from data source 401 to include in an index. For example, ingestion 410 may extract both metadata descriptive of data objects (e.g., document-wide metadata describing author, title, publisher, etc.) and the data itself (e.g., as document text passages). Once obtained, the ingested data 412 may be provided to index generation 420 for index creation.

Index generation 420 may implement various indexing techniques in order to perform searches for data when performing a natural language task, as discussed below with regard to FIGS. 5 and 6. For example, an index to support natural language search and may model the underlying extracted data using fields, vectors, or other representations to support searches for data by a data retriever. Different types of indexes may be implemented in different embodiments. For example, a sparse index may be created that indexes for data on a particular field, including those data objects (e.g., documents) with the field.

A request to add a repository without indexing 404 may be performed by updating 405 the data repository metadata 430 (and may include schema information for searching/accessing the data repository). For example, the request may provide location information, such as a network address, access credentials, data format or other schema information, in order to allow a data retriever to obtain data for a retrieval pipeline when performing a natural language task, as discussed below.

FIG. 5 is a logical block diagram illustrating interactions with a retrieval system of a generative natural language application service, according to some embodiments. Retrieval request handler 510 (which may receive requests dispatched from front-end 211) may accept different retrieval 215 requests. For example, a request to add 501, remove 502, update 503, describe 504, or list 505 retrievers may causes corresponding reads/writes 512 to the retriever configuration data 520. As part of adding and updating retrievers in retriever configuration data 520, features such as the network location or endpoint of a data repository (e.g., repositories with and without indexing), authentication and authorization parameters, network configuration information (e.g., to communicate with data repositories in private networks), access control information, retriever configuration such as the number of items to retrieve, whether to paginate results, data filtering, or various other data manipulations that may be performed on retrieved data (e.g., to reformat the retrieved data).

Similar to data connectors discussed above, different data retrievers 530 may implement respective interface components for generating and sending data retrieval requests to respective data repositories. For example, one type of data retriever 530 can read data from one type of index and another type of data retriever 530 can read data from another type of index (or external data repository).

Requests to invoke selected retrievers 506, may cause retrieval request handler 510 to dispatch queries 514 to the selected data retrievers 530 which may access 532 data in data repository(ies) 540. The schema information for some data repositories may be known (as it may have been generated when ingesting an indexing the data repository). For other data repositories which are external or otherwise not indexed/ingested, schema information (which may be provided as part of an add retriever request 501) may be used to search and return relevant data. As discussed below with regard to FIG. 6, these data retrievers may be invoked by natural language task orchestration 213.

FIG. 6 is a logical block diagram illustrating a data orchestration workflow for handling natural language requests, according to some embodiments. As discussed above, natural language task orchestration 213 may interact with different services of generative natural language service 210 in order to perform natural language tasks. For example, session store 214 may be accessed to obtain conversation history information for a given natural language request, data access management 217 may be accessed to obtain specific data retrieval user information to enforce access controls for associated data repositories and retrieval 215 may be invoked to obtain relevant data. The following description provides an example of a task orchestration workflow that may be performed for each received task by natural language task orchestration 213 as requested by generative applications.

A natural language request for a natural language task may be received, as indicated at 604. Task orchestration workflow 600 may implement conversation history 610. Conversation history 610 may obtain (if any) past conversations in order to perform decontextualization. For example, a user identifier and/or session identifier, may be used to perform a query/search on session store 220 for other requests performed for an end user of the generative application. A number of past sessions may be obtained (if any exists). The number may, in some embodiments, be determined according to a window of past conversations, turns, or other tasks, out of a larger number of stored conversations, turns, or tasks (e.g., n most recent conversations). The conversation data may be obtained and provided for further processing. If no conversation history exists, then an entry, data structure, or file may be created to store conversation history (including the current natural language request and task 602).

Intent classification model 620, may be used to classify the intent of a natural language request, including tasks that are directly sent to prompt generation 640 and generative language model 650. In some embodiments, intent classification model 620 may be a rules-based model that selects different intent classifications based on heuristics or other rules indicative of different intents (e.g., looking for mathematical operators or conjunctions in requests to determine multi-part, such as “add X's revenue summary to Y's cash flow report to generate a combined financial summary” or “If X policy type is available in Y state, then generate the X policy type using Z's information”).

In some embodiments, intent classification model 620 may be implemented using machine learning based approaches may be implemented for intent classifier model 620. For example, a neural network-based language model such as Bidirectional Encoder Representations from Transformers (BERT) or Robustly Optimized BERT pre-training Approach (ROBERTA). These or various other machine learning models may be trained to recognize different intents. For example, generic conversation natural language requests like “Hello” or “How are you?” can be detected by training the intent classifier model 620 to recognize phatic intent (which does not need data retrieval pipeline 630). For instruction or command intents, that include requests such as “write email, summarize text, write article, etc.” the intent classifier model 620 can be further trained to detect instruction intent (including general and conversational commands). Intent classification model 620 can also be trained to recognize keyword requests (which may be queries that just type in a keyword without other context. For example, keyword requests may lack sufficient semantics and could be very short or technical. They possibly do not use a generative model (e.g., data retrieval may be sufficient) or might require some query rewriting to make them semantically meaningful. For example, IP search “172.1.2.100” or searching for specific terms like “MX-52113” which may be a product number. Multi-part tasks can be similarly trained as well.

For some tasks, single (or multi-part) may be processed through retrieval augmented generation pipeline 630. Intent classification model 620 may class tasks as retrieval tasks and non-retrieval tasks, with retrieval tasks being processed through retrieval pipeline 630 and on-retrieval tasks directly to prompt generation 640. In some embodiments, a multi-part task may include a number (e.g., 0 to n) of both retrieval and non-retrieval tasks. Non-retrieval tasks may include generic conversation interactions (e.g., “Chit-chat” such as “Hello”, “Welcome to ABC . . . ”, etc.) as well as tasks that can be performed without a data retrieval (e.g., “Please divide 50,000 by 5,000”). Retrieval tasks may include instructions (e.g., “summarize”, “describe”, etc.), keywords (e.g., common entities in data repositories), and questions (sometimes referred to as “queries”). If conversation history is obtained, the conversation history may be provided to a generative language model (e.g., an LLM) to rewrite the instruction, keyword, or question based on the conversation history (e.g., replacing ambiguous terms that can be determined from the conversation history such as replacing pronouns with names or entities, adding additional terms, such as “X's product or Y's service”, etc.). The rewrite prompt may cause the generative machine learning model to return a rewritten form of the natural language request to perform the task (e.g., instruction or question) with the ambiguities or other clarifications made by conversation history incorporated. In no conversation history, then query rewriter 632 may be skipped, in some embodiments.

Application principal store 636 may be used to provide local user credentials or information to be used when retrieving data at data retrieval 634 (according to the techniques discussed below with regard to FIG. 7 that may map an end user of a generative application's service user identifier to local identifiers at individual data repositories for ACL enforcement purposes. Data retrieval 634 may select, as indicated at 635, the appropriate data retrievers (according to the application's configuration when created or updated as discussed above with regard to FIG. 3). Once relevant data passages are obtained, they are provided to prompt generation 640.

In various embodiments, prompt generation 640 may implement a rules-based prompt generator which, according to a classification type, may generate a prompt (e.g., by completed a corresponding prompt template for each classification type) with the request and, if applicable, relevant data retrieved at pipeline 630 and rewritten request at 632. Generative machine learning model 650 may be trained to generate natural language responses to generated prompts at 540. In some embodiments, generative machine learning model 650 may be an LLM, including a privately developed or maintained Foundation Model (FM), which may use millions or billions of parameters in order to generate a response to the prompt. As part of the prompt, a requirement may be included to use the provided relevant data (retrieved via pipeline 630) so that generative machine learning model 650 may not return a response that hallucinates. Generative machine learning model 650 may be hosted as part of natural language generative application service, or hosted as a separate service of provider network 200. In some embodiments, generative application creation may support selecting a particular generative machine learning model out of multiple available models, including ones hosted externally to provider network 200.

A result of generative language model 650 may then be evaluated 660 for completion (e.g., last part of a multi-part question, or validation check to determine whether the result is valid (if not an error or other failure indication may be sent)).For example, natural language task orchestration 213 may track the number of parts of a task completed and return to earlier stages in workflow 630 to perform additional stages (e.g., based on the output of a prior part, or not based on prior output).

In some embodiments, sources may be attributed 670 for retrieved data used to generate the result. For example, as discussed above, annotations or other indications of the retrieved documents (e.g., based on document-wide metadata from which retrieved document passages are obtained) may be used to annotate the response. In some embodiments, an additional machine learning model trained to detect profane or other in appropriate content may be invoked on the result to ensure that the result is not invalid for inappropriate content. In some embodiments, a response 604 indicating that the question cannot be answered (e.g., due to inappropriate result or lack of relevant data to provide from retrieval pipeline) may be sent. Otherwise, response 604 may be sent based on the generated response from generative machine learning model 650.

FIG. 7 is a logical block diagram illustrating template-based tuning of a generative machine learning model, according to some embodiments. As indicated 710, training data for different natural language tasks supported by natural language generative applications managed/created/or supported by natural language generative application service 210 may be obtained. Tuning data set curation 720 may identify and pull a mixture of tasks (e.g., according to various ratios or proportions of natural language tasks which may vary according to a determined workload/mixture of different natural language tasks for the generative machine learning model). Tuning data set curation 720 may augment or add further information to training data or generate additional training for different natural language tasks, in some embodiments. For example, in order to achieve a ratio for different natural language tasks, some additional training examples for a specific natural language task may be created as part of training data set curation.

Tuning data set with specified task mixture 730 may be provided to model fine tuning 740. Model fine tuning 740 may execute fine tuning technique(s) to adapt the parameters of the generative machine learning model, using tuning data set 730. Shared prompt template(s) 760 may also be provided as well as the model to be tuned 750. For example, model fine tuning may use the one or more shared prompt templates to generate prompts for different natural language tasks when performing fine tuning techniques. As noted above, fine-tuning refers to further training performed on a given machine learning model that may adapt the parameters of the machine learning model toward specific knowledge areas or tasks through the use of additional training data. In this case, model fine tuning may fine tune both on the tuning data set 730 and the use of different shared prompt template(s) 760 to formulate generate prompts the results of which are then evaluated and used to make model parameter adjustments as part model fine turning. When complete, tuned generative machine learning model 770 may be provided or deployed for generative applications that perform natural language tasks.

Although FIGS. 2-7 have been described and illustrated in the context of a provider network implementing a natural language generative application service, the various components illustrated and described in FIGS. 2-7 may be easily applied to other natural query language processing techniques, systems, or devices that provide. As such, FIGS. 2-7 are not intended to be limiting as to other embodiments of a system that may implement natural language query processing. FIG. 8 is a high-level flowchart illustrating various methods and techniques to implement template-based tuning of a generative machine learning model for performing natural language tasks, according to some embodiments.

Various different systems and devices may implement the various methods and techniques described below, either singly or working together. For example, a business intelligence service such as described above with regard to FIGS. 2-7 may implement the various methods. Alternatively, a combination of different systems and devices may implement these methods. Therefore, the above examples and or any other systems or devices referenced as performing the illustrated method, are not intended to be limiting as to other different components, modules, systems, or configurations of systems and devices.

As indicated at 810, a natural language request may be received via an interface of a generative machine learning system to perform a natural language task, in some embodiments. For example, a hosted or non-hosted generative application may send a request to an interface of the generative machine learning service (e.g., via an API) to perform the natural language task. The request may include or be identified with an existing session (e.g., an existing or ongoing chat) using network communication features, such as tokens and/or cookies, and utilizing bi-directional communication protocols, in some embodiments. In some embodiments, the natural language task may not be received from a generative application, but rather be received directly via an interface, such as programmatic (e.g., API), command line, or graphical user interface.

As indicated at 820, portion(s) of a shared template may be identified to complete as part of generating a prompt to perform the natural language task, in some embodiments. For example, as discussed above with regard to FIG. 6, an intent classification model which may be rules based or a trained machine learning model may classify an intent of the natural language task. The intent classification may be mapped to one of many different templates corresponding to different intent classifications. As noted above with regard to FIG. 7, multiple shared templates may be available and thus intent classification may be used to select which shared template and which field(s) in the shared template. A rules-based prompt generator may complete the prompt using the identified portions of the shared template, as well as other data, such as data retrieved from one or more associated data repositories for data retrieval tasks (and without data for non-retrieval tasks).

As indicated at 830, a generative machine learning model may be instructed to perform the prompt generated according to the shared template, in various embodiments. The generative machine learning model may have been tuned (as discussed above with regard to FIG. 1 and FIG. 7) to perform multiple natural language tasks, including the natural language task. The generative machine learning model may have been tuned by completing identified portions of the shared template for the natural language tasks using a tuning data set, in some embodiments.

As indicated at 840, a response to the natural language request based, at least in part, on a result received from the generative machine learning model, may be returned via the interface of the generative machine learning system, in some embodiments. Other post-result processing may be performed, as discussed above, including source attribution, validation, appropriate response verification, or completeness of the task processing workflow may be performed, in some embodiments.

FIG. 9 is a high-level flowchart illustrating various methods and techniques to implement template-based tuning of a generative machine learning model, according to some embodiments. As indicated at 910, a mixture of data for training to perform different natural language tasks to include in a tuning data set may be obtained, in some embodiments. As indicated at 920, fine-tuning may be performed on a generative machine learning model for performing the different natural language tasks using the tuning data set, in some embodiments. As indicated at 930, prompts may be generated according to different portions of a shared template identified for completion for the different natural language tasks, in some embodiments. For example, as discussed above with regard to FIG. 7, different training inputs from the tuning data set may be obtained and used to generate prompts. Results generated by the generative machine learning model may then be evaluated using the ground truth for the tuning data set and used to update the parameters of the generative machine learning model.

The methods described herein may in various embodiments be implemented by any combination of hardware and software. For example, in one embodiment, the methods may be implemented by a computer system (e.g., a computer system as in FIG. 10) that includes one or more processors executing program instructions stored on a computer-readable storage medium coupled to the processors. The program instructions may be configured to implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of template-based tuning of a generative machine learning model for performing natural language tasks as described herein may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, computing system compute system, or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025, may implement the various methods and techniques as described herein, and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. For example, leader nodes within a data warehouse system may present data storage services and/or database services to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
a plurality of computing devices, respective comprising at least one processor and a memory, configured to implement a generative machine learning system, configured to:
receive, via an interface, a natural language request to perform a natural language task;
identify one or more portions of a shared template to complete according to a classification determined for the natural language request;
generate a prompt to perform the natural language task with the identified one or more portions of the shared template completed;
instruct a generative machine learning model to perform the prompt generated according to the shared template, wherein the generative machine learning model was tuned to perform a plurality of natural language tasks, including the natural language task, according to completing identified portions of the shared template for the plurality of natural language tasks using a tuning data set;
return, via the interface, a response to the natural language request based, at least in part, on a result received from the generative machine learning model.

2. The system of claim 1, wherein the generative machine learning system is further configured to search one or more data repositories to obtain data to include in a context portion of the shared template when generating the prompt.

3. The system of claim 1, wherein the generative machine learning model was tuned according to a specified mixture of different natural tasks included in a tuning data set.

4. The system of claim 1, wherein the generative machine learning system is a natural language generative application service offered by a provider network and wherein the natural language request is a received from a natural language generative application created at the natural language generative application service.

5. A method, comprising:
receiving, via an interface of a generative machine learning system, a natural language request to perform a natural language task;
identifying one or more portions of a shared template to complete as part of generating a prompt to perform the natural language task;
instructing a generative machine learning model to perform the prompt generated according to the shared template, wherein the generative machine learning model was tuned to perform a plurality of natural language tasks, including the natural language task, according to completing identified portions of the shared template for the plurality of natural language tasks using a tuning data set;
returning, via the interface of the generative machine learning system, a response to the natural language request based, at least in part, on a result received from the generative machine learning model.

6. The method of claim 5, further comprising searching one or more data repositories to obtain data to include in a context portion of the shared template when generating the prompt.

7. The method of claim 5, wherein the prompt is generated without obtaining data from one or more data repositories to complete a portion of the prompt.

8. The method of claim 5, wherein identifying the one or more portions of the shared template to complete as part of generating a prompt to perform the natural language task comprises determining an intent classification for the natural language request to perform the natural language task, wherein the intent classification is mapped to the one or more portions of the shared template to complete.

9. The method of claim 5, wherein at least one portion of the shared template is not completed as part of generating the prompt.

10. The method of claim 5, wherein the shared template comprises an instruction portion, a context portion, a history portion, and a query portion.

11. The method of claim 5, wherein the generative machine learning model is one of a plurality of generative machine learning models available for performing natural language tasks, and wherein the generative machine learning model is selected to perform the natural language request for the natural language task.

12. The method of claim 5, wherein the generative machine learning model was tuned according to a specified mixture of different natural tasks included in a tuning data set.

13. The method of claim 5, wherein the generative machine learning system is a natural language generative application service offered by a provider network and wherein the natural language request is a received from a natural language generative application created at the natural language generative application service.

14. One or more non-transitory, computer-readable storage media, storing program instructions that when executed on or across one or more computing devices cause the one or more computing devices to implement:
receiving, via an interface, a natural language request to perform a natural language task;
identifying one or more portions of a shared template to complete as part of generating a prompt to perform the natural language task;
causing a generative machine learning model to perform the prompt generated according to the shared template, wherein the generative machine learning model was tuned to perform a plurality of natural language tasks, including the natural language task, according to completing identified portions of the shared template for the plurality of natural language tasks using a tuning data set;
returning, via the interface a response to the natural language request based, at least in part, on a result received from the generative machine learning model.

15. The one or more non-transitory, computer-readable storage media of claim 14, storing further program instructions that when executed on or across the one or more computing devices, cause the one or more computing devices to further implement searching one or more data repositories to obtain data to include in a context portion of the shared template when generating the prompt.

16. The one or more non-transitory, computer-readable storage media of claim 14, wherein the prompt is generated without obtaining data from one or more data repositories to complete a portion of the prompt.

17. The one or more non-transitory, computer-readable storage media of claim 14, wherein, in identifying the one or more portions of the shared template to complete as part of generating a prompt to perform the natural language task, the program instructions cause the one or more computing devices to implement determining an intent classification for the natural language request to perform the natural language task, wherein the intent classification is mapped to the one or more portions of the shared template to complete.

18. The one or more non-transitory, computer-readable storage media of claim 14, wherein at least one portion of the shared template is not completed as part of generating the prompt.

19. The one or more non-transitory, computer-readable storage media of claim 14, wherein the generative machine learning model was tuned according to a specified mixture of different natural tasks included in a tuning data set.

20. The one or more non-transitory, computer-readable storage media of claim 14, wherein the generative machine learning system is a natural language generative application service offered by a provider network and wherein the natural language request is a received from a natural language generative application created at the natural language generative application service.
